(19) United States
(12) Patent Application Publication
(10) Pub. No.: US 2003/0148107 A1
(43) Pub. Date: Aug. 7, 2003

(54) Halogen-free nonflammable epoxy resin composition, halogen-free nonfammable epoxy resin composition for build-up type multi-layer board, prepreg, copper-clad laminate, printed wiring board, copper foil-attached resin film, carrier-attached resin film, build-up type laminate, and build-up type multi-layer board

(75) Inventors: Tetsuaki Suzuki, Kawaguchi-shi (JP); Shiniti Kazama, Kawasaki-shi (JP); Tsuyoshi Sugiyama, Kawasaki-shi (JP); Hiroki Kamiya, Kawasaki-shi (JP); Noriko Kanemaki, Kawaguchi-shi (JP); Kei Ogawa, Kawaguchi-shi (JP); Yuji Tada, Tokushima-shi (JP)

Correspondence Address: Cooper & Dunham LLP, 1185 Avenue of the Americas, New York, NY, 10036, US

(73) Assignee: KYOCERA CHEMICAL CORPORATION

(21) Appl. No.: 10/337,488

(22) Filed: Jan. 7, 2003

Related U.S. Application Data
(63) Continuation of application No. PCT/JP01/06134, filed on Jul. 16, 2001.

(30) Foreign Application Priority Data
Jul. 18, 2000 (JP) 2000-216726
Jul. 25, 2000 (JP) 2000-223225

(51) Int. Cl. B32B 27/38

(52) U.S. Cl. 428/413

(57) ABSTRACT

A halogen-free nonflammable epoxy resin composition, which comprises, as essential components (A) at least one kind of a cross-linked phenoxyphosphazene compound, (B) at least one kind of polyepoxide compound such as bisphenol A epoxy resin, (C) a curing agent for epoxy such as bisphenol A novolac resin, and (D) a cure promoter for epoxy, wherein the epoxy resin composition further comprises 0 to 50% by weight of an inorganic filler.

### CROSS-REFERENCE TO RELATED APPLICATIONS

This is a Continuation Application of PCT Application No. PCT/JP01/06134, filed Jul. 16, 2001, which was not published under PCT Article 21(2) in English.

This application is based upon and claims the benefit of priority from the prior Japanese Patent Applications No. 2000-216726, filed Jul. 18, 2000; and No. 2000-223225, filed Jul. 25, 2000, the entire contents of both of which are incorporated herein by reference.

### BACKGROUND OF THE INVENTION

1. Field of the Invention

The present invention relates to a halogen-free nonflammable epoxy resin composition, to a prepreg and a laminate which are impregnated with this epoxy resin composition, to a copper-clad laminate impregnated with this epoxy resin composition, and to a printed wiring board impregnated with this epoxy resin composition. The present invention also relates to a halogen-free nonflammable epoxy resin composition for a build-up type multi-layer board, to a RCC (Resin Coated Copper foil) wherein this epoxy resin composition is coated and semi-cured, to a carrier-attached resin film wherein this epoxy resin composition is coated and semi-cured, to a build-up type laminate wherein this epoxy resin composition is coated and semi-cured, and to a build-up type multi-layer board wherein this epoxy resin composition is coated and semi-cured.

2. Description of the Related Art

In recent years, concomitant with increasing concerns for the problems of the global environment as well as for safety to the human body, there is increasing demand for electric and electronic instruments which are less harmful and much safer in the use thereof in addition to the nonflammability thereof than has been conventionally required. Namely, the electric and electronic instruments are now required to be not only nonflammable but also minimal in the generation of poisonous gases and fumes.

Conventionally, printed wiring boards made of glass-reinforced epoxy resin for mounting electric/electronic components thereon have been generally manufactured by making use of a nonflammable bromine-containing epoxy resin or a brominated epoxy resin, in particular, tetrabromo-bisphenol a epoxy resin as the epoxy resin component thereof. This epoxy resin is excellent in flame retardant properties. However, this brominated epoxy resin is accompanied by the problem that poisonous hydrogen halide (hydrogen bromide) is generated as it is burnt. Furthermore, there is a possibility that this brominated epoxy resin may become a cause for generating brominated dioxin and furans. For these reasons, there is an increasing trend to restrict the employment of brominated epoxy resin.

Under the circumstances, various kinds of epoxy resin compositions mixed with an additive such as a nitrogen compound, a phosphorus compound or an inorganic compound, have been disclosed in British Patent No. 1,112,139 or in Japanese Patent Unexamined Publication (Kokai) H2-269730. However, the additives disclosed in these publications are defective in that the curing of epoxy resin is badly affected by these compounds. Further, there is another problem that these epoxy resin compositions that have been cured become poor in humidity resistance and heat resistance.

On the other hand, it is now important for the printed wiring board to enable it to cope with the employment of a lead-free solder in addition to the aforementioned characteristics that it is halogen-free and nonflammable. As for this lead-free solder, an Sn/Ag/(Bi) type solder and an Sn/Zn/(Bi) type solder are now employed mainly because of the excellent reliability of these solders. However, these solders are higher in flow or reflow temperature than the ordinary flow or reflow temperature (about 240° C.) of the conventional Pb/Sn type eutectic solder (mp: 183° C.), i.e. 10 to 20° C. higher than that of the conventional Pb/Sn type eutectic solder. As a result, it is required for the substrate thereof to have a higher heat resistance than that of the conventional substrate.

### BRIEF SUMMARY OF THE INVENTION

An object of the present invention is to provide a nonflammable epoxy resin composition, which is halogen-free, excellent in nonflammability, applicable to a lead-free solder, and excellent in heat resistance.

Another object of the present invention is to provide a prepreg which is impregnated with the aforementioned nonflammable epoxy resin composition, and to also provide a laminate, a copper-clad laminate and a printed wiring board, all of which being manufactured using the aforementioned prepreg and being excellent in moisture resistance and heat resistance.

A further object of the present invention is to provide a nonflammable epoxy resin composition for a build-up type multi-layer board, the nonflammable epoxy resin composition being halogen-free, excellent in nonflammability, applicable to a lead-free solder, and excellent in heat resistance.

Still another object of the present invention is to provide a RCC (Resin Coated Copper foil) or a carrier-attached resin film, wherein the aforementioned nonflammable epoxy resin composition for a build-up type multi-layer board is coated thereon and semi-cured, and to also provide a build-up type laminate as well as a build-up type multi-layer board, all of which being manufactured using the aforementioned resin films and being excellent in moisture resistance and heat resistance.

As a result of intensive studies made by the present inventors with an aim to achieve the aforementioned objects, it has been found out that when a cross-linked phenoxyphosphazene compound is suitably combined with an epoxy compound and other optional compounds to form a resin composition, it is possible through this novel combination to improve the moisture resistance and heat resistance of the resin composition, thereby achieving the aforementioned objects.

Namely, there is provided according to the present invention a halogen-free nonflammable epoxy resin composition, which comprises, as essential components,:

(A) at least one kind of a cross-linked phenoxyphosphazene compound;

(B) at least one kind of polyepoxide compound;

(C) a curing agent for epoxy; and

(D) a cure promoter for epoxy;

wherein the epoxy resin composition further comprises 0 to 50% by weight of an inorganic filler.

Further, according to the present invention, there is also provided a prepreg comprising the aforementioned nonflammable epoxy resin composition which is impregnated in a glass matrix.

Further, according to the present invention, there is also provided a laminate comprising a plurality of prepreg layers which are superimposed on each other and cured.

Further, according to the present invention, there is also provided a copper-clad laminate board comprising a substrate formed of a cured prepreg, and a copper foil which is bonded to at least one side of the substrate.

Further, according to the present invention, there is also provided a printed wiring board comprising a substrate formed of a cured prepreg, and a wiring circuit formed of a copper foil which is formed on at least one side of the substrate.

There is also provided according to the present invention a halogen-free nonflammable epoxy resin composition for a build-up type multi-layer board, which comprises, as essential components,:

(A) at least one kind of a cross-linked phosphazene compound;

(B) at least one kind of polyepoxide compound;

(C) a curing agent for epoxy;

(D) a cure promoter for epoxy; and

(E) a thermoplastic resin or a thermosetting resin having a weight average molecular weight of 10,000 or more;

wherein the epoxy resin composition further comprises 0 to 50% by weight of an inorganic filler.

Further, according to the present invention, there is also provided a RCC (Resin Coated Copper foil) comprising the aforementioned nonflammable epoxy resin composition for a build-up type multi-layer board, which is coated on one side of the copper foil, and dried to semi-cure the epoxy resin composition.

Further, according to the present invention, there is also provided a build-up type laminate comprising a plurality of the RCC (Resin Coated Copper foil), which are successively laminated on at least one side of an inner circuit board, wherein the copper foil of the RCC which is located inside the laminate is etched to form a circuit.

Further, according to the present invention, there is also provided a build-up type multi-layer board comprising a plurality of the RCC (Resin Coated Copper foil), which are successively laminated on at least one side of an inner circuit board, wherein the copper foils of the RCC which are located inside and on the surface of the laminate are etched to form a circuit, and desired portions of the circuits located inside and on the surface of the laminate are electrically connected with each other via a through-hole.

Further, according to the present invention, there is also provided a carrier-attached resin film comprising the aforementioned nonflammable epoxy resin composition for a build-up type multi-layer board, which is coated on one side of a carrier sheet, and dried to semi-cure the epoxy resin composition.

### BRIEF DESCRIPTION OF THE SEVERAL VIEWS OF THE DRAWING

FIG. 1 is a cross-sectional view illustrating a copper-clad laminate according to the present invention;

FIGS. 2A, 2B and 2C are cross-sectional views each illustrating a step of manufacturing a printed wiring board according to the present invention;

FIG. 3 is a cross-sectional view illustrating a build-up type laminate according to the present invention; and

FIGS. 4A to 4E are cross-sectional views each illustrating a step of manufacturing a build-up type multi-layer printed wiring board according to the present invention.

### DETAILED DESCRIPTION OF THE INVENTION

Next, the present invention will be further explained in detail.

A halogen-free nonflammable epoxy resin composition according to the present invention comprises, as essential components,:

(A) at least one kind of a cross-linked phenoxyphosphazene compound;

(B) at least one kind of polyepoxide compound;

(C) a curing agent for epoxy; and

(D) a cure promoter for epoxy;

wherein the epoxy resin composition further comprises 0 to 50% by weight of an inorganic filler.

Next, each of these components will be explained in detail.

(A) Cross-Linked phenoxyphosphazene Compound:

As for the examples of phenoxyphosphazene compound before they are cross-linked, there is not any particular limitation as long as they are derived from a reaction between a dichlorophosphazene and an alkali metal salt of phenols, so that various kinds of phenoxyphosphazene compound which are conventionally known can be employed. Specific examples of such phenoxyphosphazene compounds include a cyclic phenoxyphosphazene compound represented by the following structural formula (1), and a linear phenoxyphosphazene compound represented by the following structural formula (2).

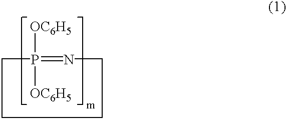

wherein

m is an integer ranging from 3 to 25.

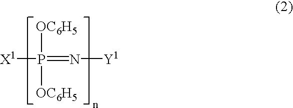

wherein

X¹ is a group of —N═P(OC₆H₅)₃ or —N═P(O)OC₆H₅; Y¹ is a group of —P(OC₆H₅)₄ or —P(O)(OC₆H₅)₂; and n is an integer ranging from 3 to 10000.

This cross-linked phenoxyphosphazene compound is obtained by cross-linking at least one kind of phosphazene compound selected from the aforementioned cyclic phenoxyphosphazene compound and linear phenoxyphosphazene compound, by using at least one kind of cross-linking group selected from the group consisting of an o-phenylene group, m-phenylene group, p-phenylene group and bis-penylene group represented by the following general formula (I).

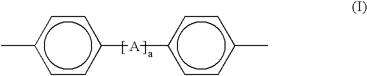

wherein

A is —C(CH₃)₂—, —SO₂—, —S— or —O—; and a is an integer of 0, 1 or more.

This cross-linked phenoxyphosphazene compound has features in that:

(a) The cross-linking group is interposed between a pair of oxygen atoms which are derived from the elimination of a phenyl group in the phosphazene compound;

(b) The ratio of the phenyl group in the cross-linked compound is 50 to 99.9% based on the total number of phenyl groups existing in at least one compound selected from the aforementioned cyclic phenoxyphosphazene compound and linear phenoxyphosphazene compound; and

(c) There is no free hydroxyl group in the molecule thereof.

Incidentally, the terminal groups X¹ and Y¹ in the aforementioned structural formula (2) are caused to change depending on the reaction conditions. For example, when the reaction is performed moderately in a non-aqueous system under ordinary reaction conditions, this structural formula (2) would be formed of a structure wherein X¹ is —N═P(OC₆H₅)₃, and Y¹ is —P(OC₆H₅)₄. On the other hand, when the reaction is performed under the reaction conditions where water or alkali metal hydroxide is permitted to exist in the reaction system, or under severe-reaction conditions where a rearrangement reaction is caused to take place, this structural formula (2) would be formed of a mixture of two kinds of structure, i.e. one structure wherein X¹ is —N═P(OC₆H₅)₃, and Y¹ is —P(OC₆H₅)₄, and the other structure wherein X¹ is —N═P(O)OC₆H₅, and Y¹ is —P(O)(OC₆H₅)₂.

The expression “there is no free hydroxyl group in the molecule thereof” in the aforementioned item (c) means that when the molecule is analyzed for free hydroxyl group according to the acetylation method using acetic anhydride and pyridine as described in the publication, “Handbook of Analytical Chemistry” (Revised Edition No. 3, The Japanese Society for Analytical Chemistry, Maruzen Publication Co., Ltd., 1981), p. 353, the quantity of the free hydroxyl groups is less than the detection limit. The “detection limit” in this case means the detection limit of hydroxyl equivalent per 1 g of a specimen (the cross-linked phenoxyphosphazene compound of the present invention), more specifically, not more than 1×10⁻⁶ hydroxyl equivalent/g. Incidentally, if the cross-linked phenoxyphosphazene compound of the present invention is analyzed by the aforementioned acetylation method, the quantity of hydroxyl groups of the residual raw phenol is also included in the resultant data. However, since the quantity of this raw phenol can be determined by means of high-performance liquid chromatography, only the quantity of free hydroxyl groups existing in the cross-linked phenoxyphosphazene compound can be determined.

This cross-linked phenoxyphosphazene compound can be manufactured by the following method. Namely, first of all, alkali metal phenolate and diphenolate are mixed with dichlorophosphazene compound to permit a reaction to take place to obtain a reaction compound, which is subsequently allowed to react further with alkali metal phenolate to produce the cross-linked phenoxyphosphazene compound.

As for the dichlorophosphazene compound to be employed in the aforementioned manufacturing method, it is possible to employ a cyclic dichlorophosphazene compound represented by the following structural formula (3), and a linear dichlorophosphazene compound represented by the following structural formula (4). Further, these dichlorophosphazene compounds can be employed singly or in combination of two or more kinds thereof. Further, the cyclic dichlorophosphazene compound and the linear dichlorophosphazene compound can be mixed with each other.

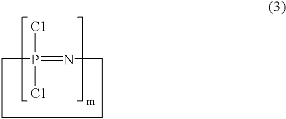

wherein

m is an integer ranging from 3 to 25.

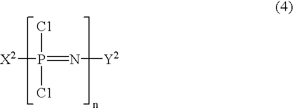

wherein

X² is a group of —N═PCl₃ or —N═P(O) Cl; Y² is a group of —PCl₄ or —P(O)Cl₂; and n is an integer ranging from 3 to 10000.

These chlorophosphazene compounds can be manufactured according to known methods set forth for example by H. R. Allcock, “Phosphorus-Nitrogen Compounds”, Academic Press, (1972), and by J. E. Mark, H. R. Allcock and R. West, “Inorganic Polymer”, Prentice-Hall International Inc., (1992).

As for the alkali metal phenolate to react with these chlorophosphazene compounds, it is possible to employ, for example, sodium phenolate, potassium phenolate, lithium phenolate, etc. These alkali metal phenolates can be employed singly or in combination of two or more kinds thereof.

As for the diphenolate to react with the aforementioned chlorophosphazene compounds, it is possible to employ, for example, o-, m- or p-substituted alkali metal diphenolate represented by the following general formula (II), and alkali metal diphenolate represented by the following general formula (III).

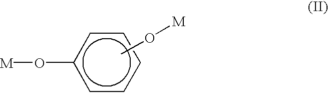

wherein

M is alkali metal.

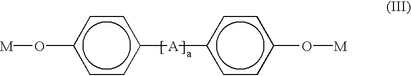

wherein

A is —C(CH₃)₂, —SO₂—, —S— or —O—; “a” is 0 or an integer of not less than 1; M is alkali metal; and the substituting position of the phenolate represented by the aforementioned general formula (II) may be ortho position, meta position or para position.

As for the aforementioned alkali metal diphenolate, it is possible to employ, for example, sodium salts or lithium salts of resorcinol, hydroquinone, catechol, 4,4′-isopropylidene diphenol (bisphenol-A), 4,4′-sulfonyl diphenol (bisphenol-S), 4,4′-thiodiphenol, 4,4′-oxydiphenol, 4,4′-diphenol, etc. These alkali metal diphenolates can be employed singly or in combination of two or more kinds thereof.

The ratio of phenyl groups to be included in the aforementioned cross-linked phenoxyphosphazene compound should preferably be confined within the range of 50 to 99.9%, more preferably within the range of 70 to 90% based on the total number of phenyl groups existing in at least one kind of compound selected from cyclic phenoxyphosphazene compound and linear phenoxyphosphazene compound.

The cross-linked phenoxyphosphazene compounds that have been cross-linked through the cross-linking group represented by the aforementioned general formula (I) are preferable for use, especially because of the fact that these cross-linked phenoxyphosphazene compounds can be decomposed at a temperature ranging from 250° C. to 350° C. These cross-linked phenoxyphosphazene compounds can be employed singly or in combination of two or more kinds thereof on the occasion of incorporating them into the epoxy resin composition of the present invention. These cross-linked phenoxyphosphazene compounds should be selected from those having a ldecomposition-beginning temperature of 300° C. or more in order to secure sufficient heat resistance for realizing lead-free soldering.

These cross-linked phenoxyphosphazene compounds should preferably be incorporated into the epoxy resin composition at a ratio of 2 to 50% by weight based on the total weight of the epoxy resin composition. If the ratio of these cross-linked phenoxyphosphazene compounds is less than 2% by weight, the nonflammability of cured product may become insufficient. On the other hand, if the ratio of these cross-linked phenoxyphosphazene compounds exceeds 50% by weight, the glass transition point of the cured product is caused to drop, thereby degrading the heat resistance of the cured product.

(B) Polyepoxide Compound:

As for the examples of polyepoxide compound, it is preferable to employ glycidyl ether type epoxy resins. Specific examples of such glycidyl ether type epoxy resins include bisphenol A epoxy resin, bisphenol F epoxy resin, novolac type epoxy resin, etc. These glycidyl ether type epoxy resins can be employed singly, or as a mixture consisting of two or more kinds thereof. This polyepoxide compound also includes glycidyl ether type modified epoxy resins. For example, bismaleimide triazine resin (BT resin) can be employed as the aforementioned modified epoxy resin.

(C) Curing Agent for Epoxy:

As for the examples of the curing agent for epoxy, it is possible to employ at least one kind of materials selected from the group consisting of dicyandiamide (DICY) and the derivatives thereof, novolac type phenol resin, amino-modified novolac type phenol resin, polyvinyl phenol resin, boron trifluoride-amine complex, organic acid hydrazide, diaminomaleonitrile and the derivatives thereof, melamine and the derivatives thereof, amine imide, polyamine salts, molecular sieve, amine, acid anhydride, polyamide and imidazole.

(D) Curing Promotor for Epoxy:

As for the curing promoter for epoxy, it is possible to employ at least one kind of material selected from the group consisting of tertiary amine, imidazole and aromatic amine.

Inorganic Fillers:

As for the examples of the inorganic fillers, it is possible to employ silica, alumina, talc, calcium carbonate, magnesium carbonate, zinc borate, zinc oxide, potassium titanate, silicon nitride, boron nitride, aluminum hydroxide, magnesium hydroxide, etc. These inorganic fillers can be employed singly or in combination of two or more kinds thereof. In particular, in the case of obtaining an epoxy resin composition where the heat resistance thereof is required to be enhanced, it is preferable to employ inorganic fillers other than metal hydroxides such as aluminum hydroxide, magnesium hydroxide, etc.

These inorganic fillers should preferably be incorporated into the epoxy resin composition at a ratio of 0 to 50% by weight based on the total weight of the epoxy resin composition including the inorganic filler. If the mixing ratio of these inorganic fillers exceeds over 50% by weight, problems may be raised on the occasion of dissolving the epoxy resin composition in an organic solvent to form a solution (varnish), which is then coated on and impregnated into a porous glass substrate to prepare a prepreg that the viscosity of the solution is excessively increased to generate the non-uniformity or voids in the prepreg.

By the way, the halogen-free non-flammable epoxy resin composition according to the present invention may further contain, as required and as long as the objects of the present invention are not hindered, a non-flammability-promoting agent such as melamines, guanamines, melamine resin and guanamine resin; or a nitrogen compound constituting a curing agent. Furthermore, a coupling agent such as epoxy silane, aminosilane, etc., may be incorporated, as required, into the non-flammable epoxy resin composition.

Next, (1) prepreg, (2) laminate, (3) copper-clad laminate, and (4) printed wiring board, for the manufacture of which the halogen-free non-flammable epoxy resin composition according to the present invention can be employed will be explained.

(1) Prepreg

First of all, the aforementioned epoxy resin composition is dissolved in an organic solvent such as propylene glycol monomethyl ether to prepare a varnish. Then, this varnish is coated on and impregnated into a porous glass substrate such as a non-woven glass fabric and a glass fabric to prepare an epoxy resin composition-impregnated substrate, which is then heated at a temperature of 150 to 170° C. to thereby manufacture a prepreg.

(2) Laminate

A plurality of the prepregs obtained by the method of aforementioned item (1) are superimposed or each other to obtain a laminate, which is then heated and pressed under ordinary conditions, for example, at a temperature of 170° C. and under a pressure of 4 MPa for 100 minutes to manufacture a laminate.

Alternatively, the laminate may be formed in such a way that a copper foil is additionally superimposed on each of all of the prepregs except those to be disposed at the outermost layers of the laminate, and the resultant laminate is heated and pressed. Thereafter, only the copper foil is etched to manufacture a laminate having an inner circuit.

(3) Copper-Clad Laminate

A plurality of the prepregs obtained by the method of aforementioned item (1) are superimposed to each other to obtain a laminate. Then, copper foil is laminated on one or both of the surfaces of this laminate. The resultant laminate is then heated and pressed under the ordinary conditions, for example, at a temperature of 170° C. and under a pressure of 4 MPa for 100 minutes to manufacture a copper-clad glass epoxy laminate.

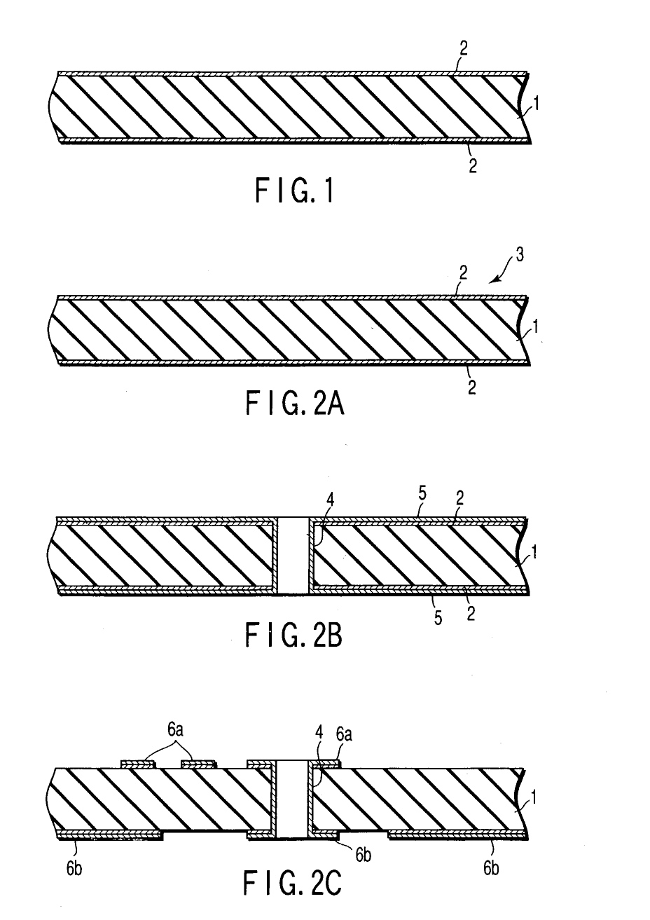

FIG. 1 shows the structure of the copper-clad laminate as described above. Specifically, this copper-clad laminate is constructed such that the copper foil 2 is bonded to at least one side (for example, both sides) of the laminate 1.

Alternatively, the copper-clad laminate may be formed in such a way that a copper foil is additionally superimposed on each of all of the prepregs except those to be disposed at the outermost layers of the laminate, and the resultant laminate is heated and pressed. Thereafter, only the copper foil is etched to manufacture a copper-clad laminate having an inner circuit.

(4) Printed Wiring Board

A plurality of the prepregs obtained by the method of aforementioned item (1) are superimposed or each other to obtain a laminate. Then, copper foil is laminated on one or both of the surfaces of this laminate. The resultant laminate is then heated and pressed under ordinary conditions, for example, at a temperature of 170° C. and under a pressure of 4 MPa for 100 minutes to manufacture a copper-clad glass epoxy laminate. Then, desired portions of the copper-clad laminate are opened to form holes, to which a through-hole plating is performed. Thereafter, the copper foil is etched together with the plated film so as to form a circuit to thereby manufacture a printed wiring board.

Next, the manufacturing steps of this printed wiring board will be explained with reference to FIGS. 2A, 2B and 2C. First of all, a plurality of the prepregs are superimposed to each other to obtain a laminate. Then, copper foil is laminated, for example, on both surfaces of this laminate. The resultant laminate is then heated and pressed under the ordinary conditions, for example, at a temperature of 170° C. and under a pressure of 4 MPa for 100 minutes to manufacture a copper-clad glass epoxy laminate 3 as shown in FIG. 2A, wherein the copper foil 2 is attached to both surfaces of the laminate 1. Then, as shown in FIG. 2B, desired portions of the copper-clad laminate 3 are opened to form holes, to which a through-hole plating is performed to form a through-hole 4. On this occasion, a plated film 5 is formed also on the copper foil 2 formed on both surfaces of the copper-clad laminate 3. Thereafter, as shown in FIG. 2C, the copper foil 2 is selectively etched together with the plated film 5 by making use of an etching mask (not shown) to form circuits 6a and 6b made of the copper foil 2 and the plated film 5, thereby manufacturing the printed wiring board.

Alternatively, the printed wiring board may be formed in such a way that copper foil is additionally superimposed on each of all of the prepregs except those to be disposed at the outermost layers of the laminate, and the resultant laminate is heated and pressed. Thereafter, only the copper foil is etched to manufacture a copper-clad laminate having an inner circuit.

Next, the resin composition for a build-up type multi-layer board according to the present invention will be further explained in detail.

This resin composition for a build-up type multi-layer board comprises, as essential components,:

(A) at least one kind of a cross-linked phosphazene compound;

(B) at least one kind of polyepoxide compound;

(C) a curing agent for epoxy;

(D) a cure promoter for epoxy; and

(E) a thermoplastic resin or a thermosetting resin having a weight average molecular weight of 10,000 or more;

wherein the epoxy resin composition further comprises 0 to 50% by weight of an inorganic filler.

The components of the aforementioned items (A) to (D) may be constituted by the same materials as those explained in the aforementioned halogen-free nonflammable epoxy resin composition.

The purpose of incorporating the thermoplastic resin or a thermosetting resin having a weight average molecular weight of 10,000 or more into the nonflammable epoxy resin composition is to facilitate the formation of film by making use of the nonflammable epoxy resin composition for a build-up type multi-layer board, so that these thermoplastic and thermosetting resins should preferably be selected from those which are excellent in adhesivity and flexibility. Specific examples of these resins include, for example, epoxy resin, phenoxy resin, urethane resin, polyimide resin, polyvinyl butyral, polyvinyl acetal, polyvinyl formal, polyamide, polyacetal, polycarbonate, modified polyphenylene oxide, polybutylene terephthalate, enforced polyethylene terephthalate, polyallylate, polysulfone, polyether sulfone, polyether imide, polyamide imide, polyphenylene sulfide, polyether etherketone, etc. These resins can be employed singly or in combination of two or more kinds thereof.

If the weight average molecular weight of these resins is less than 10,000, the film-forming performance thereof may be degraded.

In particular, thermosetting resins having a thermosetting group at the main chain or side chain thereof as well as thermoplastic resins having a thermosoftening point of 90° C. or more are preferable for use as these resins are capable of enhancing the heat resistance and moisture resistance of the nonflammable epoxy resin composition for build-up type multi-layer board.

The mixing ratio of the aforementioned component (E) should preferably be confined to the range of 5 to 80% by weight based on the total weight of the epoxy resin composition.

As for the examples of the inorganic fillers, it is possible to employ silica, alumina, talc, calcium carbonate, magnesium carbonate, zinc borate, zinc oxide, potassium titanate, silicon nitride, boron nitride, aluminum hydroxide, magnesium hydroxide, etc. These inorganic fillers can be employed singly or in combination of two or more kinds thereof. In particular, in the case of obtaining an epoxy resin composition where the heat resistance thereof is required to be enhanced, it is preferable to employ inorganic fillers other than metal hydroxides such as aluminum hydroxide, magnesium hydroxide, etc.

These inorganic fillers should preferably be incorporated into the epoxy resin composition at a ratio of 0 to 50% by weight based on the total weight of the epoxy resin composition including the inorganic filler. If the mixing ratio of these inorganic fillers exceeds 50% by weight, problems may be raised on the occasion of dissolving the epoxy resin composition in an organic solvent to form a solution, which is then coated to form a resin film, that the viscosity of the solution is excessively increased to generate non-uniformity or voids in the coated layer. In particular, when it is desired to form a resin film by making use of an epoxy resin composition containing any of the aforementioned fillers, the mixing ratio of the aforementioned inorganic fillers should preferably be confined to the range of 3 to 50% by weight based on the total weight of the epoxy resin composition. This is because if the mixing ratio of these inorganic fillers is less than 3% by weight, it may become difficult to provide the resin film formed of the epoxy resin composition with sufficient heat resistance.

Next, (1) RCC (Resin Coated Copper foil), (2) build-up type laminate, (3) build-up type multi-layer printed wiring board, and (4) carrier-attached resin film, for the manufacture of which the halogen-free non-flammable epoxy resin composition for build-up type multi-layer board according to the present invention can be employed will be explained.

(1) RCC

First of all, the aforementioned nonflammable epoxy resin composition for build-up type laminate is dissolved in an organic solvent such, for example, as methyl cellosolve to prepare a varnish. Then, this varnish is coated on one side of a copper foil and dried to cure the varnish to manufacture a RCC.

(2) Build-Up Type Laminate

At least one sheet of the RCC obtained by the method of aforementioned item (1) is superimposed on one side or-both sides of an inner circuit board-to prepare a build-up type laminate.

If two or more sheets of the aforementioned RCCs are to be superimposed on the circuit board, the copper foil of the RCC which is disposed at the inner portion of the laminate should be etched to form a circuit, which is then electrically connected with the circuit of the inner circuit board via a plated through-hole.

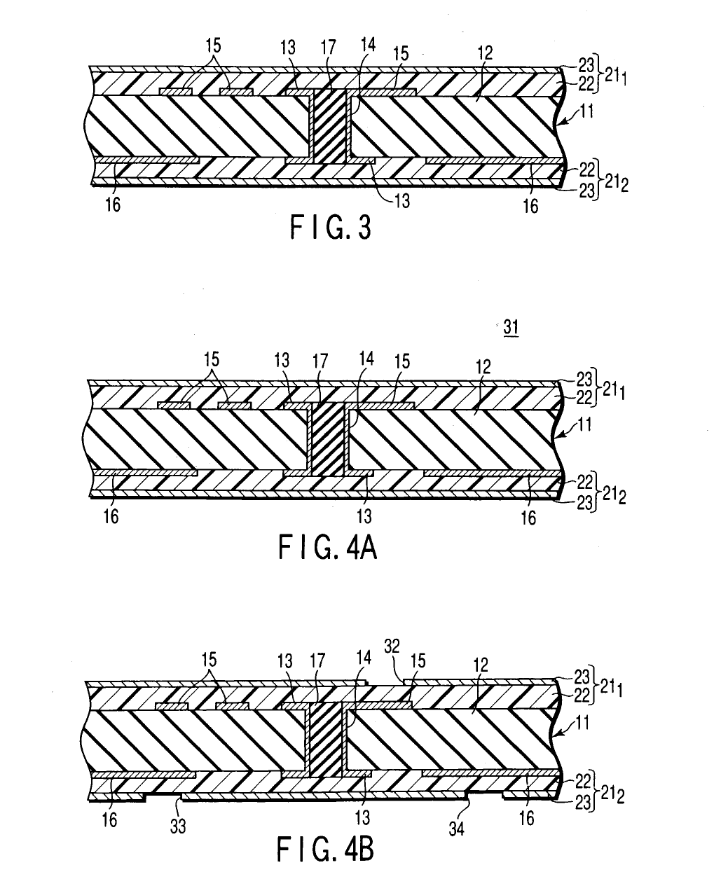

The specific structure of this build-up type laminate is shown in FIG. 3. Namely, this build-up type laminate is constructed such that a pair of RCCs 21₁ and 21₂ that have been produced by the aforementioned method (1) are respectively attached to, for example, both surfaces of an inner circuit board 11. This inner circuit board 11 is constituted by an insulating board 12, a through-hole 14 formed piercing the insulating board 12 and accompanied with a couple of lands 13 which are respectively formed on both surfaces of the insulating board 12, and a pair of first circuit 15 and second circuit 16 which are respectively formed on both surfaces of the insulating board 12. By the way, the through-hole 14 is filled therein with a packing 17 formed of an insulating material. The RCCs 21₁ and 21₂ are respectively constituted by a resin film 22 which is adhered to each of the both surfaces of the inner circuit board 11, and a copper foil 23 which is attached to the outer surface of the resin film 22, i.e. the surface located remote from the inner circuit board 11.

(3) Build-Up Type Multi-Layer Printed Wiring Board

A plurality of sheets of the RCC obtained by the method of aforementioned item (1) are respectively superimposed on one side or both sides of an inner circuit board to form a laminate, and the copper foil of the RCCs which are located at the inner portion and the outer surface portion of the laminate is etched so as to form a circuit, respectively, the circuits located at the inner portion and the outer surface portion of the laminate being optionally and electrically connected with each other via a through-hole, thereby producing a build-up type multi-layer printed wiring board.

If two or more sheets of the aforementioned resin coated copper foils are to be superimposed on the circuit board, the copper foil of the RCC which is disposed at the inner portion of the laminate should be etched to form a circuit, which is then electrically connected with the circuit of the inner circuit board via a plated through-hole.

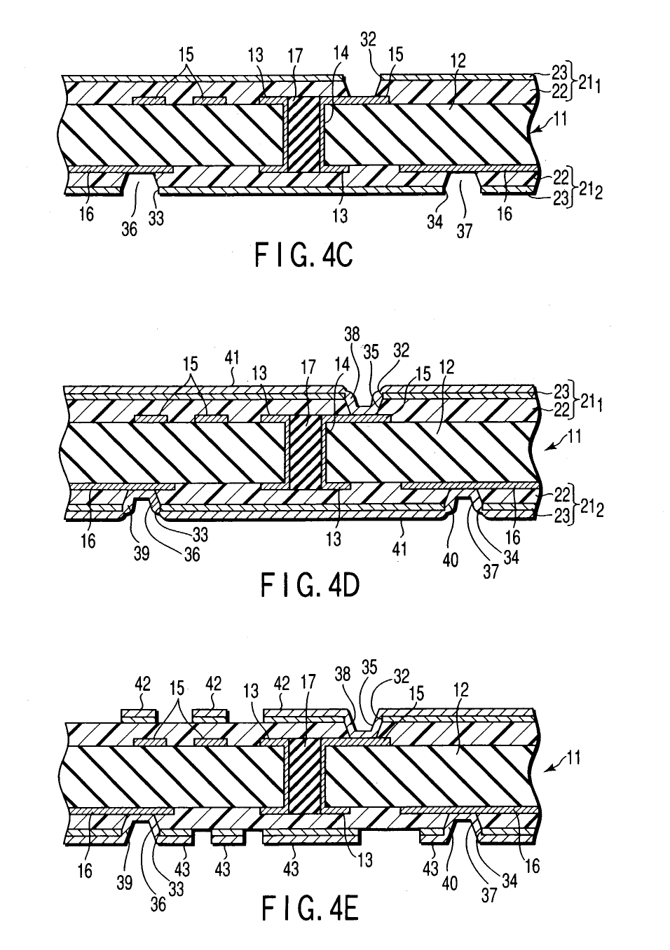

The specific structure of this build-up type multi-layer printed wiring board will be illustrated with reference to FIGS. 4A, 4B, 4C, 4D and 4E.

Namely, this build-up type multi-layer printed wiring board is constructed such that a pair of RCCs 21₁ and 21₂ each comprising the resin film 22 and the copper foil, and produced by the aforementioned method (1) are respectively attached to, for example, both surfaces of an inner circuit board 11 by making use of the resin films 22 which are respectively heated and pressed in this laminating process, thereby producing a build-up type laminate structure 31 as shown in FIG. 4A. By the way, this inner circuit board 11 is constituted by an insulating board 12, a through-hole 14 formed piercing through the insulating board 12 and accompanied with a couple of lands 13 which are respectively formed on both surfaces of the insulating board 12, and a pair of first circuit 15 and second circuit 16 which are respectively formed on both surfaces of the insulating board 12. Further, the through-hole 14 is filled therein with a packing 17 formed of an insulating material.

Then, as shown in FIG. 4B, part of the copper foil 23 of the RCC 21₁ is etched away in conformity with the first circuit 15 to form an opening 32. Further, part of the copper foil 23 of the RCC 21₂ is etched away in conformity with the second circuit 16 to form openings 33 and 34. Thereafter, as shown in FIG. 4C, the portions of the resin film 22 that are exposed through these openings 32, 33 and 34 are selectively etched away to form a hole 35 which is extended to the first circuit 15 as well as holes 36 and 37 which are extended to the second circuit 16. Subsequently, the resultant board is subjected to nonelectrolytic plating or electroplating to thereby form a plated through-hole 38 electrically connected with the first circuit 15 and plated through-holes 39 and 40 electrically connected with the second circuit 16 as shown in FIG. 4D. On this occasion, a plating film 41 is also formed on the surface of each of the copper foils 23 of the RCCs 21₁ and 21₂ attached to both surfaces of circuit board 11. Thereafter, this plating film 41 as well as the copper foils 23 of the RCCs 21₁ and 21₂ are selectively etched away to form a second layer 42 of the first circuit and a second layer 43 of the second circuit, thereby manufacturing a build-up type multi-layer printed wiring board.

(4) Carrier-Attached Resin Film

First of all, the aforementioned nonflammable epoxy resin composition for build-up type laminate is dissolved in an organic solvent such, for example, as methyl cellosolve to prepare a varnish. Then, this varnish is coated on one side of a carrier sheet made of a resin such as polyester, polyimide, etc. and dried to semi-cure the varnish to manufacture a carrier-attached resin film.

Incidentally, the halogen-free non-flammable epoxy resin composition for build-up multi-layer board according to the present invention may further contain, as required and as-long as the objects of the present invention are not hindered, a non-flammability-promoting agent such as melamines, guanamines, melamine resin and guanamine resin; or a nitrogen compound constituting a curing agent. Furthermore, a coupling agent such as epoxy silane, aminosilane, etc., may be incorporated, as required, into the non-flammable epoxy resin composition.

Next, preferable examples of the present invention will be explained. The present invention should not be construed as being limited by these examples. In the following examples and comparative examples, the expression “part(s)” means “part(s) by weight”.

The synthesizing examples of cross-linked phenoxyphosphazene compounds will be explained as follows.

### SYNTHESIS EXAMPLE 1

(The Synthesis of a phenoxyphosphazene Compound having a Crosslinked Structure where p-phenylene was Employed as a Crosslinking Group)

A mixture consisting of 103.5 g (1.1 moles) of phenol, 44.0 g (1.1 moles) of sodium hydroxide, 50 g of water and 500 mL of toluene was refluxed under heating to remove only water out of the system to prepare a toluene solution of sodium phenolate.

Simultaneous with the aforementioned reaction, a mixture consisting of 16.5 g (0.15 moles) of hydroquinone, 94.1 g (1.0 mole) of phenol, 31.1 g (1.3 moles) of lithium hydroxide, 52 g of water and 600 mL of toluene was introduced into a four-neck 2L flask and refluxed under heating to remove only water out of the system to prepare a toluene solution of lithium salt of hydroquinone and phenol. To this toluene solution, 580 g of a 20% chlorobenzene solution containing 1.0 unit mole (115.9 g) of dichlorophosphazene oligomer (62% of trimer, 12% of tetramer, 11% of pentamer and hexamer, 3% of heptamer, and 12% of octamer and other higher oligomers) was dropped with stirring and at a temperature of not higher than 30° C. The resultant mixture was further heated with stirring at a temperature of 110° C. for 3 hours to allow a reaction to take place. Thereafter, the aforementioned toluene solution of sodium phenolate that had been prepared in advance as mentioned above was added with stirring to the reaction mixture, and the resultant mixture was heated at a temperature of 110° C. for 4 hours to continue the reaction.

After finishing the reaction, the reaction mixture was washed three times with 1.0L of a 3% aqueous solution of sodium hydroxide, and a further three times with 1.0L of water. Then, the organic phase was allowed to condense under a reduced pressure, and the resultant product was heated at a temperature of 80° C. under a pressure of 3 mmHg or less for 11 hours and allowed to dry in vacuum to obtain 211 g of light yellowish powder (compound X).

The cross-linked phenoxyphosphazene compound thus obtained was found containing 0.04% of hydrolytic chlorine and, as a result of the analysis on the content of phosphorus and the elemental analysis of CHN, having a final composition of: [N═P(—O-p-C₆H₄—O—)0.15(—O-p-C₆H₅)1.7]. The weight average molecular weight (Mw) of the cross-linked phenoxyphosphazene compound was 1,100 as it was calculated based on polystyrene standard (by means of GPC analysis). This cross-linked compound indicated no clear melting point as it was analyzed based on TG/DTA, with the ldecomposition-beginning temperature thereof being 306° C. and the 5% weight-loss temperature thereof being 311° C. Further, when the quantitative analysis of residual hydroxyl group was performed by means of acetylation method, the residual hydroxyl group was found less than detection limit (not more than 1×10⁻⁶ equivalent/g as measured based on hydroxyl equivalent per 1 g of sample).

### SYNTHESIS EXAMPLE 2

The Synthesis of a phenoxyphosphazene Compound having a Crosslinked Structure where 2,2-bis(p-oxyphenyl)isopropylidene was Employed as a Crosslinking Group

65.9 g (0.7 moles) of phenol, and 500 mL of toluene were introduced into a four-neck 1L flask, and then, 0.65 gram atom (14.9 g) of finely cut pieces of metal sodium was introduced, with stirring, into the flask while maintaining the inner liquid temperature thereof at 25° C. Thereafter, the stirring was continued for 8 hours while maintaining the inner liquid temperature thereof at 77-113° C. until the metal sodium was completely disappeared.

Simultaneous with the aforementioned reaction, 0.25 moles (57.1 g) of bisphenol-S, 1.1 moles (103.5 g) of phenol, and 800 mL of tetrahydrofuran (THF) were introduced into a four-neck 3L flask, and then, 1.6 gram atoms (11.1 g) of finely cut pieces of metal lithium was introduced, with stirring, into the flask while maintaining the inner liquid temperature thereof at 25° C. Thereafter, the stirring was continued for 8 hours while maintaining the inner liquid temperature thereof at 61-68° C. until the metal lithium was completely disappeared, thus obtaining a slurry. To this slurry, 1.0 mole (115.9 g) of dichlorophosphazene oligomer (Concentration: 313 g of 37% chlorobenzene solution; Composition: 75% of trimer, 17% of tetramer, 6% of pentamer and hexamer, 1% of heptamer, and 1% of octamer and other higher oligomers) was dropped over one hour with stirring and at an inner liquid temperature of not higher than 20° C. The resultant mixture was further heated at a temperature of 80° C. for 2 hours to allow a reaction to take place. Thereafter, the aforementioned sodium phenolate solution that had been prepared separately as mentioned above was added over one hour with stirring to the reaction mixture while maintaining the inner liquid temperature of 20° C., and the resultant mixture was further heated at a temperature of 80° C. for 5 hours to continue the reaction.

After finishing the reaction, the reaction mixture was concentrated, and THF was removed. Then, 1L of toluene was further added to the concentrated reaction mixture. The resultant toluene solution was washed three times with 1L of 2% aqueous solution of sodium hydroxide, and further three times with 1L of water. Then, the organic phase was allowed to concentrate under a reduced pressure, and the resultant product was heated at a temperature of 80° C. under a pressure of 3 mmHg or less for 11 hours and allowed to dry in vacuum to obtain 229 g of white powder (compound Y).

The cross-linked phenoxyphosphazene compound thus obtained was found containing 0.07% of hydrolyzable chlorine and, as a result of the analysis on the content of phosphorus and the elemental analysis of CHN, having a final composition of: [N═P(—O-p-C₆H₄—C(CH₃)₂—C₆H₄—O—)0.25(—O-p-C₆H₅)1.50]. The weight average molecular weight (Mw) of the cross-linked phenoxyphosphazene compound was 1,130 as it was calculated based on polystyrene standard (by means of GPC analysis). This cross-linked compound indicated no clear melting point as it was analyzed based on TG/DTA, with the ldecomposition-beginning temperature thereof being 308° C. and the 5% weight-loss temperature thereof being 313° C. Further, when the quantitative analysis of residual hydroxyl group was performed by means of the acetylation method, the residual hydroxyl group was found to be less than the detection limit (not more than 1×10⁻⁶ equivalent/g as measured based on a hydroxyl equivalent per 1 g of sample).

### SYNTHESIS EXAMPLE 3

The Synthesis of a phenoxyphosphazene Compound having a Crosslinked Structure where 4,4-sulfonyldiphenylene(bisphenol-S Residual Group) was Employed as a Crosslinking Group

37.6 g (0.4 moles) of phenol, and 500 mL of THF were introduced into a four-neck 1L flask, and then, 0.45 gram atom (9.2 g) of finely cut pieces of metal sodium was introduced, with stirring, into the flask while maintaining the inner liquid temperature thereof at 25° C. Thereafter, the stirring was continued for 5 hours while maintaining the inner liquid temperature thereof at 65-72° C. until the metal sodium was completely disappeared.

Simultaneous with the aforementioned reaction, 160.0 g (1.70 moles) of phenol and 12.5 g (0.05 moles) of bisphenol-S were dissolved in 500 mL of THF to obtain a solution, to which 1.8 gram atoms (41.4 g) of finely cut pieces of metal sodium was added. Thereafter, the resultant mixture was heated up to 61° C. over one hour, and stirred for 6 hours while maintaining the temperature thereof at 61-68° C. to obtain a mixed solution of sodium phenolate. This solution was dropped to 580 g of a 20% chlorobenzene solution containing 1.0 unit mole (115.9 g) of dichlorophosphazene oligomer (Composition: 62% of trimer, 12% of tetramer, 11% of pentamer and hexamer, 3% of heptamer, and 12% of occamer and other higher oligomers) with stirring and at a cooling temperature of not higher than 25° C. The resultant mixture was stirred at a temperature of 71-77° C. for 5 hours to allow a reaction to take place.

Thereafter, the aforementioned mixed solution of sodium phenolate that had been prepared in advance as mentioned above was dropped to the reaction mixture, and the resultant mixture was heated at a temperature of 71-77° C. for 3 hours to continue the reaction.

After finishing the reaction, the reaction mixture was concentrated and redissolved in 500 mL of chlorobenzene to obtain a solution, which was washed three times with a 5% aqueous solution of sodium hydroxide, with a 5% aqueous solution of sulfuric acid, with a 5% aqueous solution of sodium hydrogencarbonate, and further three times with 1.0L of water. Then, the resultant product was allowed to concentrate and dried to obtain 218 g of light yellowish wax-like material (compound Z).

The cross-linked phenoxyphosphazene compound thus obtained was found containing 0.01% of hydrolyzable chlorine and, as a result of the analysis on the content of phosphorus and the elemental analysis of CHN, having a final composition of: [N═P(—O-p-C₆H₄—SO₂—C₆H₄—O—)0.05(—O—C₆H₅)1.90]. The weight average molecular weight (Mw) of the cross-linked phenoxyphosphazene compound was 1,080 as it was calculated based on polystyrene (by means of GPC analysis). This cross-linked compound indicated a melting temperature (Tm) of 103° C. as it was analyzed based on TG/DTA, with the ldecomposition-beginning temperature thereof being 320° C. and the 5% weight-loss temperature thereof being 334° C. Further, when the quantitative analysis of residual hydroxyl group was performed by means of the acetylation method, the residual hydroxyl group was found to be less than the detection limit (not more than 1×10⁻⁶ equivalent/g as measured based on a hydroxyl equivalent per 1 g of sample).

### EXAMPLE 1

Propyleneglycol monomethyl ether (PGM) was added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 337 parts of bisphenol A novolac resin named Epiclon N850A (trade name, Dainippon Ink and Chemicals Co., Ltd., hydroxyl value: 118, solid resin content: 70% by weight), 420 parts of cross-linked phenoxyphosphazene oligomer (available from Ohtsuka Chemical Co., Ltd., the compound X of Synthesis Example 1), and 0.7 parts of 2-ethyl-4-methyl imidazole (2E4MZ), thereby preparing an epoxy resin varnish containing 65% by weight of solid resin.

### EXAMPLE 2

Propyleneglycol monomethyl ether (PGM) and dimethyl formamide (DMF) were added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 25 parts of dicyan diamide (DISY), 350 parts of cross-linked phenoxyphosphazene oligomer (available from Ohtsuka Chemical Co., Ltd., the compound X of Synthesis Example 1), and 0.8 parts of 2-ethyl-4-methyl imidazole (2E4MZ), thereby preparing an epoxy resin varnish containing 65% by weight of solid resin.

### EXAMPLE 3

Propyleneglycol monomethyl ether (PGM) was added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 337 parts of bisphenol A novolac resin named Epichlon N850A (trade name, Dainihon Ink Chemical Co., Ltd., hydroxyl value: 118, solid resin content: 70% by weight), 420 parts of cross-linked phenoxyphosphazene oligomer (available from Ohtsuka Chemical Co., Ltd., the compound Y of Synthesis Example 2), and 0.7 parts of 2-ethyl-4-methyl imidazole (2E4MZ), thereby preparing an epoxy resin varnish containing 65% by weight of solid resin.

### EXAMPLE 4

Propyleneglycol monomethyl ether (PGM) and dimethyl formamide (DMF) were added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 25 parts of dicyan diamide (DISY), 350 parts of cross-linked phenoxyphosphazene oligomer (available from Ohtsuka Chemical Co., Ltd., the compound Y of Synthesis Example 2), and 0.8 parts of 2-ethyl-4-methyl imidazole (2E4MZ), thereby preparing an epoxy resin varnish containing 65% by weight of solid resin.

### EXAMPLE 5

Propyleneglycol monomethyl ether (PGM) was added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 337 parts of bisphenol A novolac resin named Epiclon N850A (trade name, Dainippon Ink and Chemicals Co., Ltd., hydroxyl value: 118, solid resin content: 70% by weight), 420 parts of cross-linked phenoxyphosphazene oligomer (available from Ohtsuka Chemical Co., Ltd., the compound Z of Synthesis Example 3), and 0.7 parts of 2-ethyl-4-methyl imidazole (2E4MZ), thereby preparing an epoxy resin varnish containing 65% by weight of solid resin.

### EXAMPLE 6

Propyleneglycol monomethyl ether (PGM) and dimethyl formamide (DMF) were added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 25 parts of dicyan diamide (DISY), 350 parts of cross-linked phenoxyphosphazene oligomer (available from Ohtsuka Chemical Co., Ltd., the compound Y of Synthesis Example 2), 420 parts of cross-linked phenoxyphosphazene oligomer (available from Ohtsuka Chemical Co., Ltd., the compound Z of Synthesis Example 3), and 0.8 parts of 2-ethyl-4-methyl imidazole (2E4MZ), thereby preparing an epoxy resin varnish containing 65% by weight of solid resin.

### EXAMPLE 7

Propyleneglycol monomethyl ether (PGM) was added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 337 parts of bisphenol A novolac resin named Epiclon N850A (trade name, Dainippon Ink and Chemicals Co., Ltd., hydroxyl value: 118, solid resin content: 70% by weight), 270 parts of cross-linked phenoxyphosphazene oligomer (available from Ohtsuka Chemical Co., Ltd., the compound X of Synthesis Example 1), 270 parts of fused silica, and 0.7 parts of 2-ethyl-4-methyl imidazole (2E4MZ), thereby preparing an epoxy resin varnish containing 65% by weight of solid resin.

### EXAMPLE 8

Propyleneglycol monomethyl ether (PGM) and dimethyl formamide (DMF) were added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 25 parts of dicyan diamide (DISY), 230 parts of cross-linked phenoxyphosphazene oligomer (available from Ohtsuka Chemical Co., Ltd., the compound X of Synthesis Example 1), 230 parts of fused silica, and 0.8 parts of 2-ethyl-4-methyl imidazole (2E4MZ), thereby preparing an epoxy resin varnish containing 65% by weight of solid resin.

### EXAMPLE 9

Propyleneglycol monomethyl ether (PGM) was added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 337 parts of bisphenol A novolac resin named Epiclon N850A (trade name, Dainippon Ink and Chemicals Co., Ltd., hydroxyl value: 118, solid resin content: 70% by weight), 270 parts of cross-linked phenoxyphosphazene oligomer (available from Ohtsuka Chemical Co., Ltd., the compound X of Synthesis Example 1), 270 parts of aluminum hydroxide, and 0.7 parts of 2-ethyl-4-methyl imidazole (2E4MZ), thereby preparing an epoxy resin varnish containing 65% by weight of solid resin.

### EXAMPLE 10

Propyleneglycol monomethyl ether (PGM) and dimethyl formamide (DMF) were added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 25 parts of dicyan diamide (DISY), 230 parts of cross-linked phenoxyphosphazene oligomer (available from Ohtsuka Chemical Co., Ltd., the compound X of Synthesis Example 1), 230 parts of aluminum hydroxide, and 0.8 parts of 2-ethyl-4-methyl imidazole (2E4MZ), thereby preparing an epoxy resin varnish containing 65% by weight of solid resin.

### COMPARATIVE EXAMPLE 1

Propyleneglycol monomethyl ether (PGM) was added as a solvent to a mixture consisting of 600 parts of brominated epoxy resin named Epicoat 5045 (trade name, Yuka Shell Co., Ltd., epoxy equivalent: 480, solid resin content: 80% by weight), 169 parts of bisphenol A novolac resin named Epiclon N850A (trade name, Dainippon Ink and Chemicals Co., Ltd., hydroxyl value: 118, solid resin content: 70% by weight), and 0.6 parts of 2-ethyl-4-methyl imidazole (2E4MZ), thereby preparing an epoxy resin varnish containing 65% by weight of solid resin.

### COMPARATIVE EXAMPLE 2

Propyleneglycol monomethyl ether (PGM) was added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 337 parts of bisphenol A novolac resin named Epiclon N850A (trade name, Dainippon Ink and Chemicals Co., Ltd., hydroxyl value: 118, solid resin content: 70% by weight), 541 parts of triphenylene phosphate, 361 parts of aluminum hydroxide, and 0.9 parts of 2-ethyl-4-methyl imidazole (2E4MZ), thereby preparing an epoxy resin varnish containing 65% by weight of solid resin.

### COMPARATIVE EXAMPLE 3

Propyleneglycol monomethyl ether (PGM) and dimethyl formamide (DMF) were added as a solvent to a mixture consisting of 600 parts of brominated epoxy resin named Epicoat 5045 (trade name, Yuka Shell Co., Ltd., epoxy equivalent: 480, solid resin content: 80% by weight), 13 parts of dicyan diamide (DICY), and 0.5 parts of 2-ethyl-4-methyl imidazole (2E4MZ), thereby preparing an epoxy resin varnish containing 65% by weight of solid resin.

### COMPARATIVE EXAMPLE 4

Propyleneglycol monomethyl ether (PGM) and dimethyl formamide (DMF) were added as a solvent to a mixture consisting of 651 parts of bisphenol A epoxy resin named Epicoat 1001 (trade name, Yuka Shell Co., Ltd., epoxy equivalent: 456, solid resin content: 70% by weight), 300 parts of cresol novolac epoxy resin named YDCD-704P (trade name, Tohto Kasei Co., Ltd., epoxy equivalent: 210, solid resin content: 70% by weight), 25 parts of dicyan diamide (DISY), 230 parts of phenoxyphosphazene oligomer (available from Ohtsuka Chemical Co., Ltd., melting point: 100° C.), 230 parts of aluminum hydroxide, and 0.7 parts of 2-ethyl-4-methyl imidazole (2E4MZ), thereby preparing an epoxy resin varnish containing 65% by weight of solid resin.

Each varnish obtained from each of Examples 1 to 10 and Comparative Examples 1 to 4 was continuously coated on the surface of a non-woven glass fabric or a glass fabric to allow the varnish to impregnate into the glass fabric. Then, the impregnated varnish was dried at a temperature of 160° C. to thereby manufacture a prepreg.

Eight sheets of the prepregs thus obtained and each having a thickness of 180 μm were superimposed to each other to obtain a laminate. Then, copper foil having a thickness of 18 μm was laminated on both surfaces of the laminate, and then heated and pressed under the conditions of: 170° C. in temperature and 4 MPa in pressure for 100 minutes to manufacture a copper-clad glass epoxy laminate having a thickness of 1.6 mm.

Each of these copper-clad glass epoxy laminates was evaluated with respect to (1) flammability; (2) water absorption; (3) peeling strength; (4) solder resistance; and (5) measling resistance. The results are shown in the following Tables 1 to 3.

Incidentally, these Tables 1 to 3 also show the mixing ratio of the epoxy resin varnishes of Examples 1 to 10 and Comparative Examples 1 to 4.

1) Flammability

The flammability was measured according to the UL94.

2) Water Absorption

The water absorption was measured according to JIS-C-6481.

3) Peeling Strength

The peeling strength was measured based on the ordinary state (A) and the state subsequent to the aging (E) [1000 hours/180° C.] of the copper-clad laminate according to JIS-C-6481.

4) Solder Resistance

The solder resistance was evaluated by observing if there was any swelling generated after permitting the samples of the copper-clad laminate to float for 3 minutes, 5 minutes and 10 minutes in a soldering bath heated to 300° C.

5) Measling Resistance

The measling resistance was evaluated by observing if there was any swelling generated as the samples each having a width of 50 mm and a length of 50 mm and formed of a copper-clad laminate with the copper foil thereof being etched away in advance from the surface thereof were immersed for 30 seconds in a soldering bath heated to 260° C. after these samples were subjected in advance to boiling for four hours (D-4/100) and to a pressure-cooker test under the conditions of 120° C. and two hours (PCT/2 hr).

Furthermore, a plurality of the prepregs produced by making use of the epoxy resin varnish of each of Examples 1 to 10 and Comparative Examples 1 to 4 were superimposed to each other to obtain a laminate. Then, copper foil having a thickness of 35 μm was laminated on both surfaces of the laminate, and then heated and pressed under the same conditions as described above to manufacture an inner board, having a thickness of 0.8 mm. After this inner board was treated to form a wiring circuit thereon, and the surface of the copper foil was oxidized, the same kind of prepregs as mentioned above were superimposed on both surfaces of the inner board. Additionally, copper foil having a thickness of 18 μm was laminated on each of these prepregs, and the resultant laminate was heated and pressed in the same manner as described above to manufacture a multi-layer board having a thickness of 1.6 mm.

Each of these multi-layer boards thus obtained was evaluated with respect to (1) voids; (2) thin spot; (3) inner board-peeling strength; and (4) measling resistance. The results are shown in the following Tables 1 to 3.

1) Voids

The voids were evaluated by visually observing the surface of the multi-layer board after the copper foil was etched away from the surface thereof.

2) Thin Spot

The thin spot was evaluated by visually measuring the thin spot, if any, at the four corners of the multi-layer board after the copper foil was etched away from the surface of the multi-layer board.

3) Inner Board-Peeling Strength

This peeling strength was evaluated by measuring the peeling strength between the inner board of ordinary state (A) and the prepreg according to JIS-C-6481.

4) Measuring Resistance

The measuring resistance was evaluated by observing if there was any swelling generated as the samples each having a width of 50 mm and a length of 50 mm and formed of a multi-layer board with the copper foil thereof being etched away in advance from the surface thereof were immersed for 30 seconds in a soldering bath heated to 260° C. after these samples were subjected to boiling for two hours (D-2/100) and to boiling for four hours (D-4/100).

TABLE 1

Examples (parts by weight)

| | Item | | 1 | 2 |
|---|---|---|---|---|
| Composition | Epicoat 1001 | | 651 | 651 |
| | Epicoat 5045 | | — | — |
| | YDCN-704P | | 300 | 300 |
| | Epiclon N850A | | 337 | — |
| | DICY | | — | 25 |
| | Cross-linked phosphazene X | | 420 | 350 |
| | Cross-linked phosphazene Y | | — | — |
| | Cross-linked phosphazene Z | | — | — |
| | Phenoxyphosphazene oligomer | | — | — |
| | Triphenylene phosphate | | — | — |
| | Fused silica | | — | — |
| | Aluminum hydroxide | | — | — |
| | 2E4MZ | | 0.7 | 0.8 |
| | PGM | | Suitable amount | Suitable amount |
| | DMF | | — | Suitable amount |
| | Solid content (%) | | 65 | 65 |
| Characteristics | Flammability (UL94) | | V-0 | V-0 |
| of laminate | Water absorption D-24/23 (%) | | 0.03 | 0.05 |
| | Peeling strength | A | 1.4 | 1.5 |
| | (KN/m) | E-1000/180 | 1.35 | 1.45 |
| | Solder resistance | 1 min. | No swelling | No swelling |
| | [300° C. solder] | 5 min. | No swelling | No swelling |
| | | 10 min. | No swelling | No swelling |
| | Measling | D-4/100 | No swelling | No swelling |
| | resistance | PCT2hr | No swelling | No swelling |
| Characteristics | Voids | | None | None |
| of multi-layer | Thin-spot (%) | | None | None |
| board | Inner board-peeling strength | | 0.9 | 0.9 |
| A (KN/m) | | | | |
| | Measling | D-2/100 | No swelling | No swelling |
| | resistance | D-4/100 | No swelling | No swelling |

| | | | Examples (parts by weight) | | |
|---|---|---|---|---|---|
| | Item | | 3 | 4 | 5 |
| Composition | Epicoat 1001 | | 651 | 651 | 651 |
| | Epicoat 5045 | | — | — | — |
| | YDCN-704P | | 300 | 300 | 300 |
| | Epiclon N850A | | 337 | — | 337 |
| | DICY | | — | 25 | — |
| | Cross-linked phosphazene X | | — | — | — |
| | Cross-linked phosphazene Y | | 420 | 350 | — |
| | Cross-linked phosphazene Z | | — | — | 420 |
| | Phenoxyphosphazene oligomer | | — | — | — |
| | Triphenylene phosphate | | — | — | — |
| | Fused silica | | — | — | — |
| | Aluminum hydroxide | | — | — | — |
| | 2E4MZ | | 0.7 | 0.8 | 0.7 |
| | PGM | | Suitable amount | Suitable amount | Suitable amount |
| | DMF | | — | Suitable amount | — |
| | Solid content (%) | | 65 | 65 | 65 |
| Characteristics | Flammability (UL94) | | V-0 | V-0 | V-0 |
| of laminate | Water absorption D-24/23 (%) | | 0.03 | 0.04 | 0.02 |
| | Peeling strength | A | 1.4 | 1.5 | 1.5 |
| | (KN/m) | E-1000/180 | 1.35 | 1.45 | 1.45 |
| | Solder resistance | 1 min. | No swelling | No swelling | No swelling |
| | [300° C. solder] | 5 min. | No swelling | No swelling | No swelling |
| | | 10 min. | No swelling | No swelling | No swelling |
| | Measling | D-4/100 | No swelling | No swelling | No swelling |
| | resistance | PCT2hr | No swelling | No swelling | No swellign |
| Characteristics | Voids | | None | None | None |
| of multi-layer | Thin-spot (%) | | None | None | None |
| board | Inner board-peeling strength | | 0.9 | 0.9 | 1 |
| | A (KN/m) | | | | |
| | Measling | D-2/100 | No swelling | No swelling | No swelling |
| | resistance | D-4/100 | No swelling | No swelling | No swelling |

TABLE 2

Examples (parts by weight)

| | Item | | 6 | 7 |
|---|---|---|---|---|
| Composition | Epicoat 1001 | | 651 | 651 |
| | Epicoat 5045 | | — | — |
| | YDCN-704P | | 300 | 300 |
| | Epiclon N850A | | — | 337 |
| | DICY | | 25 | 13 |
| | Cross-linked phosphazene X | | — | 270 |
| | Cross-linked phosphazene Y | | 350 | — |
| | Cross-linked phosphazene Z | | 420 | — |
| | Phenoxyphosphazene oligomer | | — | — |
| | Triphenylene phosphate | | — | — |
| | Fused silica | | — | 270 |
| | Aluminum hydroxide | | — | — |
| | 2E4MZ | | 0.8 | 0.7 |
| | PGM | | Suitable amount | Suitable amount |
| | DMF | | Suitable amount | — |
| | Solid content (%) | | 65 | 65 |
| Characteristics | Flammability (UL94) | | V-0 | V-0 |
| of laminate | Water absorption D-24/23 (%) | | 0.04 | 0.02 |
| | Peeling strength | A | 1.7 | 1.5 |
| | (KN/m) | E-1000/180 | 1.7 | 1.45 |
| | Solder resistance | 1 min. | No swelling | No swelling |
| | [300° C. solder] | 5 min. | No swelling | No swelling |
| | | 10 min. | No swelling | No swelling |
| | Measling | D-4/100 | No swelling | No swelling |
| | resistance | PCT2hr | No swelling | No swelling |
| Characteristics | Voids | | None | None |
| of multi-layer | Thin-spot (%) | | None | None |
| board | Inner board-peeling strength | | 1 | 1 |
| | A (KN/m) | | | |
| | Measling | D-2/100 | No swelling | No swelling |
| | resistance | D-4/100 | No swelling | No swelling |

| | | | Examples (parts by weight) | | |
|---|---|---|---|---|---|
| | Item | | 3 | 4 | 5 |
| Composition | Epicoat 1001 | | 651 | 651 | 651 |
| | Epicoat 5045 | | — | — | — |
| | YDCN-704P | | 300 | 300 | 300 |
| | Epiclon N850A | | — | 337 | — |
| | DICY | | 25 | — | 25 |
| | Cross-linked phosphazene X | | 230 | 270 | 230 |
| | Cross-linked phosphazene Y | | — | — | — |
| | Cross-linked phosphazene Z | | — | — | — |
| | Phenoxyphosphazene oligomer | | — | — | — |
| | Triphenylene phosphate | | — | — | — |
| | Fused silica | | 230 | — | — |
| | Aluminum hydroxide | | — | 270 | 230 |
| | 2E4MZ | | 0.8 | 0.7 | 0.8 |
| | PGM | | Suitable amount | Suitable amount | Suitable amount |
| | DMF | | Suitable amount | — | Suitable amount |
| | Solid content (%) | | 65 | 65 | 65 |
| Characteristics | Flammability (UL94) | | V-0 | V-0 | V-0 |
| of laminate | Water absorption D-24/23 (%) | | 0.04 | 0.03 | 0.04 |
| | Peeling strength | A | 1.6 | 1.5 | 1.6 |
| | (KN/m) | E-1000/180 | 1.55 | 1.45 | 1.55 |
| | Solder resistance | 1 min. | No swelling | No swelling | No swelling |
| | [300° C. solder] | 5 min. | No swelling | No swelling | No swelling |
| | | 10 min. | No swelling | Partially | Partially |
| | | | | swelled | swelled |
| | Measling | D-4/100 | No swelling | No swelling | No swelling |
| | resistance | PCT2hr | No swelling | No swelling | No swelling |
| Characteristics | Voids | | None | None | None |
| of multi-layer | Thin-spot (%) | | None | None | None |
| board | Inner board-peeling strength | | 1 | 1 | 1 |
| | A (KN/m) | | | | |
| | Measling | D-2/100 | No swelling | No swelling | No swelling |
| | resistance | D-4/100 | No swelling | No swelling | No swelling |

TABLE 3

| | | | Comparative Example | |
|---|---|---|---|---|
| | | | (parts by weight) | |
| | Item | | 1 | 2 |
| Composition | Epicoat 1001 | | — | 651 |
| | Epicoat 5045 | | 600 | — |
| | YDCN-704P | | — | 300 |
| | Epiclon N850A | | 169 | 337 |
| | DICY | | — | — |
| | Cross-linked phosphazene X | | — | — |
| | Cross-linked phosphazene Y | | — | — |
| | Cross-linked phosphazene Z | | — | — |
| | Phenoxyphosphazene oligomer | | — | — |
| | Triphenylene phosphate | | — | 541 |
| | Fused silica | | — | — |
| | Aluminum hydroxide | | — | 361 |
| | 2E4MZ | | 0.6 | 0.9 |
| | PGM | | Suitable amount | Suitable amount |
| | DMF | | — | — |
| | Solid content (%) | | 65 | 65 |
| Characteristics | Flammability (UL94) | | V-0 | V-0 |
| of laminate | Water absorption D-24/23 (%) | | 0.07 | 0.13 |
| | Peeling strength | A | 1.4 | 1 |
| | (KN/m) | E-1000/180 | 0.1 | 0.7 |
| | Solder resistance | 1 min. | Partially swelling | Partially swelling |
| | [300° C. solder] | 5 min. | swelling | swelling |
| | | 10 min. | swelling | swelling |
| | Measling | D-4/100 | No swelling | No swelling |
| | resistance | PCT2hr | No swelling | Partially swelling |
| Characteristics | Voids | | None | None |
| of multi-layer | Thin-spot (%) | | None | None |
| board | Inner board-peeling strength | | 0.9 | 0.4 |
| A (KN/m) | | | | |
| | Measling | D-2/100 | No swelling | No swelling |
| | resistance | D-4/100 | No swelling | Partially swelling |
| | | | Comparative Example | |
| | | | (parts by weight) | |
| | Item | | 3 | 4 |
| Composition | Epicoat 1001 | | — | 651 |
| | Epicoat 5045 | | 600 | — |
| | YDCN-704P | | — | 300 |
| | Epiclon N850A | | — | — |
| | DICY | | 13 | 25 |
| | Cross-linked phosphazene X | | — | — |
| | Cross-linked phosphazene Y | | — | — |
| | Cross-linked phosphazene Z | | — | — |
| | Phenoxyphosphazene oligomer | | — | 230 |
| | Triphenylene phosphate | | — | — |
| | Fused silica | | — | — |
| | Aluminum hydroxide | | — | 230 |
| | 2E4MZ | | 0.5 | 0.7 |
| | PGM | | Suitable amount | Suitable amount |
| | DMF | | Suitable amount | Suitable amount |
| | Solid content (%) | | 65 | 65 |
| Characteristics | Flammability (UL94) | | V-0 | V-0 |
| of laminate | Water absorption D-24/23 (%) | | 0.08 | 0.04 |
| | Peeling strength | A | 1.5 | 1.5 |
| | (KN/m) | E-1000/180 | 0.1 | 0.45 |
| | Solder resistance | 1 min. | Partially swelling | Partially swelling |
| | [300° C. solder] | 5 min. | swelling | swelling |
| | | 10 min. | swelling | swelling |
| | Measling | D-4/100 | No swelling | No swelling |
| | resistance | PCT2hr | No swelling | No swelling |
| Characteristics | Voids | | None | None |
| of multi-layer | Thin-spot (%) | | None | None |
| board | Inner board-peeling strength | | 1 | 0.8 |
| | A (KN/m) | | | |
| | Measling | D-2/100 | No swelling | No swelling |
| | resistance | D-4/100 | No swelling | No swelling |

As can be clearly seen from the above Tables 1 to 3, the epoxy resin compositions of Examples 1 to 10 were free from halogens and hence excellent in nonflammability, enabling a glass epoxy laminate product which is excellent in heat resistance, moisture resistance and chemical resistance to be obtained.

Further, it is possible, through the employment of such a copper-clad glass epoxy laminate as described above, to manufacture a printed wiring board which is preferable in terms of environmental characteristics and also excellent in various other characteristics.

### EXAMPLE 11

Methyl cellosolve was added to a mixture consisting of 75 parts of bisphenol A epoxy resin named Epicoat 1256 (trade name, Yuka Shell Co., Ltd., weight average molecular weight: 50000, epoxy equivalent: 7900, solid resin content: 40% by weight), 28 parts of bisphenol A epoxy resin named Epicoat 1001 (trade name, Yuka Shell Co., Ltd., epoxy equivalent: 475), 6.3 parts of novolac phenol resin named BRG-558 (trade name, Showa Kohbunshi Co., Ltd., hydroxyl equivalent: 106), 5 parts of melamine, 12 parts of cross-linked phenoxyphosphazene oligomer (available from Ohtsuka Chemical Co., Ltd., the compound X of Synthesis Example 1), 25 parts of aluminum hydroxide, and 0.2 parts of 2-ethyl-4-methyl imidazole (2E4MZ), thereby preparing an epoxy resin varnish containing 50% by weight of solid resin.

### EXAMPLE 12

Methyl cellosolve was added to a mixture consisting of 75 parts of bisphenol A epoxy resin named Epicoat 1256 (trade name, Yuka Shell Co., Ltd., weight average molecular weight: 50000, epoxy equivalent: 7900, solid resin content: 40% by weight), 28 parts of bisphenol A epoxy resin named Epicoat 1001 (trade name, Yuka Shell Co., Ltd., epoxy equivalent: 475), 0.62 parts of dicyan diamide, 5 parts of melamine, 12 parts of cross-linked phenoxyphosphazene oligomer (available from Ohtsuka Chemical Co., Ltd., the compound X of Synthesis Example 1), 25 parts of aluminum hydroxide, and 0.2 part of 2-ethyl-4-methyl imidazole (2E4MZ), thereby preparing an epoxy resin varnish containing 50% by weight of solid resin.

### EXAMPLE 13

Methyl cellosolve was added to a mixture consisting of 75 parts of bisphenol A epoxy resin named Epicoat 1256 (trade name, Yuka Shell Co., Ltd., weight average molecular weight: 50000, epoxy equivalent: 7900, solid resin content: 40% by weight), 28 parts of bisphenol A epoxy resin named Epicoat 1001 (trade name, Yuka Shell Co., Ltd., epoxy equivalent: 475), 6.3 parts of novolac phenol resin named BRG-558 (trade name, Showa Kohbunshi Co., Ltd., hydroxyl equivalent: 106), 5 parts of melamine, 5 parts of cross-linked phenoxyphosphazene oligomer (available from Ohtsuka Chemical Co., Ltd., the compound X of Synthesis Example 1), 20 parts of cross-linked phenoxyphosphazene oligomer (available from Ohtsuka Chemical Co., Ltd., the compound Y of Synthesis Example 2), 25 parts of aluminum hydroxide, and 0.2 parts of 2-ethyl-4-methyl imidazole (2E4MZ), thereby preparing an epoxy resin varnish containing 50% by weight of solid resin.

### EXAMPLE 14

Methyl cellosolve was added to a mixture consisting of 75 parts of bisphenol A epoxy resin named Epicoat 1256 (trade name, Yuka Shell Co., Ltd., weight average molecular weight: 50000, epoxy equivalent: 7900, solid resin content: 40% by weight), 28 parts of bisphenol A epoxy resin named Epicoat 1001 (trade name, Yuka Shell Co., Ltd., epoxy equivalent: 475), 0.62 parts of dicyan diamide, 5 parts of melamine, 20 parts of cross-linked phenoxyphosphazene oligomer (available from Ohtsuka Chemical Co., Ltd., the compound Y of Synthesis Example 2), 25 parts of aluminum hydroxide, and 0.2 part of 2-ethyl-4-methyl imidazole (2E4MZ), thereby preparing an epoxy resin varnish containing 50% by weight of solid resin.

### EXAMPLE 15

Methyl cellosolve was added to a mixture consisting of 75 parts of bisphenol A epoxy resin named Epicoat 1256 (trade name, Yuka Shell Co., Ltd., weight average molecular weight: 50000, epoxy equivalent: 7900, solid resin content: 40% by weight), 28 parts of bisphenol A epoxy resin named Epicoat 1001 (trade name, Yuka Shell Co., Ltd., epoxy equivalent: 475), 6.3 parts of novolac phenol resin named BRG-558 (trade name, Showa Kohbunshi Co., Ltd., hydroxyl equivalent: 106), 5 parts of melamine, 18 parts of cross-linked phenoxyphosphazene oligomer (available from Ohtsuka Chemical Co., Ltd., the compound Z of Synthesis Example 3), 25 parts of aluminum hydroxide, and 0.2 parts of 2-ethyl-4-methyl imidazole (2E4MZ), thereby preparing an epoxy resin varnish containing 50% by weight of solid resin.

### EXAMPLE 16

Methyl cellosolve was added to a mixture consisting of 75 parts of bisphenol A epoxy resin named Epicoat 1256 (trade name, Yuka Shell Co., Ltd., weight average molecular weight: 50000, epoxy equivalent: 7900, solid resin content: 40% by weight), 28 parts of bisphenol A epoxy resin named Epicoat 1001 (trade name, Yuka Shell Co., Ltd., epoxy equivalent: 475), 0.62 parts of dicyan diamide, 5 parts of melamine, 18 parts of cross-linked phenoxyphosphazene oligomer (available from Ohtsuka Chemical Co., Ltd., the compound Z of Synthesis Example 3), 25 parts of aluminum hydroxide, and 0.2 parts of 2-ethyl-4-methyl imidazole (2E4MZ), thereby preparing an epoxy resin varnish containing 50% by weight of solid resin.

### COMPARATIVE EXAMPLE 5

Methyl cellosolve was added to a mixture consisting of 75 parts of bisphenol A epoxy resin named Epicoat 1256 (trade name, Yuka Shell Co., Ltd., weight average molecular weight: 50000, epoxy equivalent: 7900, solid resin content: 40% by weight), 28 parts of brominated epoxy resin named Epiclon 1121 (trade name, Dainippon Ink and Chemicals Co., Ltd., epoxy equivalent: 490), 6.1 parts of novolac phenol resin named BRG-558 (trade name, Showa Kohbunshi Co., Ltd., hydroxyl equivalent: 106), 25 parts of aluminum hydroxide, and 0.2 parts of 2-ethyl-4-methyl imidazole (2E4MZ), thereby preparing an epoxy resin varnish containing 50% by weight of solid resin.

### COMPARATIVE EXAMPLE 6

Methyl cellosolve was added to a mixture consisting of 75 parts of bisphenol A epoxy resin named Epicoat 1256 (trade name, Yuka Shell Co., Ltd., weight average molecular weight: 50000, epoxy equivalent: 7900, solid resin content: 40% by weight), 35 parts of brominated epoxy resin named Epiclon 1121 (trade name, Dainippon Ink and Chemicals Co., Ltd., epoxy equivalent: 490), 0.8 parts of dicyan amide, 25 parts of aluminum hydroxide, and 0.2 parts of 2-ethyl-4-methyl imidazole (2E4MZ), thereby preparing an epoxy resin varnish containing 50% by weight of solid resin.

Each epoxy resin varnish obtained from each of Examples 11 to 16 and Comparative Examples 5 and 6 was continuously coated on one side of a copper foil having a thickness of 18 μm and dried at a temperature of 150° C. to thereby manufacture a RCC (Resin Coated Copper foil). Thereafter, this RCC was laminated on both surfaces of a laminate which prepared in advance by making use of a halogen-free resin composition. Then, the resultant laminate body was heated and pressed under the conditions of 170° C. temperature and 4 MPa pressure for 90 minutes to manufacture a build-up type multi-layer board having a thickness of 0.6 mm.

Each of these build-up type multi-layer boards was evaluated, as explained below, with respect to (1) flammability; (2) insulating resistance; (3) peeling strength; (4) solder resistance; (5) measling resistance; (6) analysis of combustion gas. The results are shown in the following Table 4. Incidentally, this Table 4 also shows the mixing ratio of the epoxy resin varnishes of Examples 11 to 15 and Comparative Examples 5 and 6.

1) Flammability

The flammability was measured according to UL94.

2) Insulating Resistance

The insulating resistance was measured according to IEC-PB112.

3) Peeling Strength

The peeling strength was measured based on the ordinary state (A) and the state subsequent to the aging (E) [500 hours/177° C.] of the multi-layer board according to JIS-C-6481.

4) Solder Resistance

The solder resistance was evaluated by observing if there was any swelling generated after permitting the samples of the multi-layer board to float for 3 minutes, 5 minutes and 10 minutes in a soldering bath heated to 300° C.

5) Measling Resistance

The measling resistance was evaluated by observing if there was any swelling generated as the samples each having a width of 50 mm and a length of 50 mm and formed of a multi-layer board with the copper foil thereof being etched away in advance from the surface thereof were immersed for 30 seconds in a soldering bath heated to 260° C. after these samples were subjected to boiling for two hours (D-2/100) and to boiling for four hours (D-4/100).

6) Analysis of Combustion Gas

The analysis of combustion gas was in such a way that a sample of the multi-layer board was allowed to burn in air atmosphere under the conditions of: 750° C. in temperature and 10 minutes in period, and the gas generated on this occasion was allowed to be absorbed in a liquid absorbent and subjected to the analysis thereof by means of ion chromatography.

TABLE 4

| | | | Example (parts by weight) | | | |
|---|---|---|---|---|---|---|
| | Item | | 11 | 12 | 13 | 14 |
| Composi- | Epicoat 1256 | | 75 | 75 | 75 | 75 |
| tion | Epicoat 1001 | | 28 | 28 | 28 | 28 |
| | Epiclon 1121 | | — | — | — | — |
| | BRG-558 | | 6.3 | — | 6.3 | — |
| | Dicyan diamide | | — | 0.62 | — | 0.62 |
| | Melamine | | 5 | 5 | 5 | 5 |
| | Cross-linked phosphazene X | | 12 | 12 | 5 | — |
| | Cross-linked phosphazene Y | | — | — | 20 | 20 |
| | Cross-linked phosphazene Z | | — | — | — | — |
| | Aluminum hydroxide | | 25 | 25 | 25 | 25 |
| | 2E4MZ | | 0.2 | 0.2 | 0.2 | 0.2 |
| | Methylcellosolve | | Suitable | Suitable | Suitable | Suitable |
| | | | amount | amount | amount | amount |
| | Solid content (%) | | 50 | 50 | 50 | 50 |
| Charac- | Flammability (UL94) | | V-0 | V-0 | V-0 | V-0 |
| teristics | Insulating resistance | | 3 | 2.9 | 3.2 | 3.1 |
| of | (× 10¹⁴ Ω) | | | | | |
| laminate | 1EG-PM112 | | | | | |
| | Peeling strength | A | 1.1 | 1.28 | 1.16 | 1.3 |
| | (KN/m) | E-500/177 | 0.98 | 1.2 | 1.1 | 1.22 |
| | Solder | 3 min. | No swelling | No swelling | No swelling | No swelling |
| | resistance | 5 min. | No swelling | No swelling | No swelling | No swelling |
| | [300 C.] solder | 10 min. | Partially | Partially | Partially | Partially |
| | | | swelled | swelled | swelled | swelled |
| | Moisture | D-2/100 | No swelling | No swelling | No swelling | No swelling |
| | resistance | D-4/100 | No swelling | No swelling | No swelling | No swelling |
| | Analysis of combustion gas | | 0 | 0 | 0 | 0 |
| | Concentration of hydrogen | | | | | |
| | bromide (g/100 g) | | | | | |
| | | | Example | | Comparative Examples | |
| | | | (parts by weight) | | (parts by weight) | |
| | Item | | 15 | 16 | 5 | 6 |
| Composi- | Epicoat 1256 | | 75 | 75 | 75 | 75 |
| tion | Epicoat 1001 | | 28 | 28 | — | — |
| | Epiclon 1121 | | — | — | 28 | 28 |
| | BRG-558 | | 6.3 | — | 6.1 | — |
| | Dicyan diamide | | — | 0.62 | — | 0.8 |
| | Melamine | | 5 | 5 | — | — |
| | Cross-linked phosphazene X | | — | — | — | — |
| | Cross-linked phosphazene Y | | — | — | — | — |
| | Cross-linked phosphazene Z | | 18 | 18 | — | — |
| | Aluminum hydroxide | | 25 | 25 | 25 | 25 |
| | 2E4MZ | | 0.2 | 0.2 | 0.2 | 0.7 |
| | Methylcellosolve | | Suitable | Suitable | Suitable | Suitable |
| | | | amount | amount | amount | amount |
| | Solid content (%) | | 50 | 50 | 50 | 50 |
| Charac- | Flammability (UL94) | | V-0 | V-0 | V-0 | V-0 |
| teristics | Insulating resistance | | 2.7 | 2.5 | 2 | 2 |
| of | (× 10¹⁴ Ω) | | | | | |
| laminate | 1EG-PM112 | | | | | |
| | Peeling strength | A | 1.2 | 1.33 | 1.18 | 1.3 |
| | (KN/m) | E-500/177 | 0.16 | 1.27 | 0.2 | 0.22 |
| | Solder | 3 min. | No swelling | No swelling | No swelling | No swelling |
| | resistance | 5 min. | No swelling | No swelling | No swelling | No swelling |
| | [300 C.] solder | 10 min. | Partially | Partially | Partially | Partially |
| | | | swelled | swelled | swelled | swelled |
| | Moisture | D-2/100 | No swelling | No swelling | No swelling | No swelling |
| | resistance | D-4/100 | No swelling | No swelling | No swelling | No swelling |

| | | | | |
|---|---|---|---|---|
| Analysis of combustion gas | 0 | 0 | 5.2 | 5.4 |
| Concentration of hydrogen | | | | |
| bromide (g/100 g) | | | | |

As is apparent from this Table 4, the build-up type multi-layer boards which were produced by making use of the resin compositions for build-up laminate which were prepared in Examples 11 to 16, or by making use of the RCCs prepared using these resin compositions were comparable in every characteristics to the build-up type multi-layer boards of Comparative Examples 5 and 6 where the conventional brominated epoxy resin was employed. Further, the build-up type multi-layer boards which were produced by making use of the resin compositions for build-up laminate which were prepared in Examples 11 to 16, or by making use of the RCCs prepared using these resin compositions were found excellent in peeling strength after long-term aging because of the fact that these resin compositions contained no bromine.

Moreover, the build-up type multi-layer boards which were produced by making use of the resin compositions for build-up laminate which were prepared in Examples 11 to 16, or by making use of the RCCs prepared using these resin compositions were found free from the generation of hydrogen bromide which has been considered to raise problems on the occasion of burning the multi-layer boards.

As explained above, the present invention has features in that the non-flammability of epoxy resin composition has been realized without necessitating the employment of halogens, thereby making it possible to provide a resin composition for build-up laminate which is excellent in heat resistance and moisture resistance without any possibility of generating a poisonous gas such as hydrogen bromide on the occasion of burning the resin composition. Therefore, it is now possible to manufacture carrier sheet-attached resin films and build-up type multi-layer boards which are excellent in heat resistance and moisture resistance.

What is claimed is:

1. A halogen-free nonflammable epoxy resin composition, which comprises, as essential components:
(A) at least one kind of a cross-linked phenoxyphosphazene compound;
(B) at least one kind of polyepoxide compound;
(C) a curing agent for epoxy; and
(D) a cure promoter for epoxy;
wherein said epoxy resin composition further comprises 0 to 50% by weight of an inorganic filler.

2. A halogen-free nonflammable epoxy resin composition according to claim 1, wherein the cross-linked phenoxyphosphazene compound is obtained by cross-linking at least one kind of phosphazene compound selected from a cyclic phenoxyphosphazene compound represented by the following structural formula (1) and linear phenoxyphosphazene compound represented by the following structural formula (2), by using at least one kind of cross-linking group selected from the group consisting of o-phenylene group, m-phenylene group, p-phenylene group and bis-phenylene group represented by the following general formula (I); the cross-linked phenoxyphosphazene compound being further featured in that:
(a) The cross-linking group is interposed between a pair of oxygen atoms which are derived from the elimination of phenyl group in the phosphazene compound;
(b) The ratio of the phenyl groups in the cross-linked compound is 50 to 99.9% based on the total number of phenyl groups existing in at least one compound selected from the aforementioned cyclic phenoxyphosphazene compound and linear phenoxyphosphazene compound; and
(c) There is no free hydroxyl group in the molecule thereof; 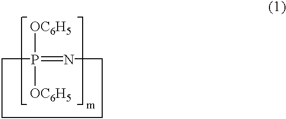
wherein
m is an integer ranging from 3 to 25. 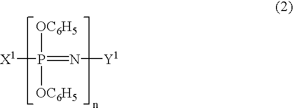
wherein
X¹ is a group of —N═P(OC₆H₅)₃ or —N═P(O)OC₆H₅; Y¹ is a group of —P(OC₆H₅)₄ or —P(O)(OC₆H₅)₂; and n is an integer ranging from 3 to 10000. 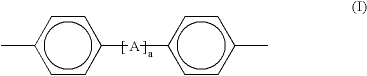
wherein
A is —C(CH₃)₂—, —SO₂—, —S— or —O—; and a is an integer of 0, 1 or more.

3. A halogen-free nonflammable epoxy resin composition according to claim 1, wherein the polyepoxide compound is glycidyl ether-based epoxy resin.

4. A halogen-free nonflammable epoxy resin composition according to claim 1, wherein the curing agent for epoxy is at least one kind of material selected from the group consisting of dicyandiamide and the derivatives thereof, novolac type phenol resin, amino-modified novolac type phenol resin, polyvinyl phenol resin, boron trifluoride-amine complex, organic acid hydrazide, diaminomaleonitrile and the derivatives thereof, melamine and the derivatives thereof, amine imide, polyamine salts, molecular sieve, amine, acid anhydride, polyamide and imidazole.

5. A halogen-free nonflammable epoxy resin composition according to claim 1, wherein the cure promoter for epoxy is at least one kind of material selected from the group consisting of tertiary amine, imidazole and aromatic amine.

6. A prepreg comprising a nonflammable epoxy resin composition which is impregnated in a glass matrix, the nonflammable epoxy resin composition comprising, as essential components: (A) at least one kind of a cross-linked phenoxyphosphazene compound; (B) at least one kind of polyepoxide compound; (C) a curing agent for epoxy; and (D) a cure promoter for epoxy; wherein the epoxy resin composition further comprises 0 to 50% by weight of an inorganic filler.

7. A laminate comprising a plurality of the prepreg layers as claimed in claim 6, which are superimposed on each other and cured.

8. A copper-clad laminate board comprising a substrate formed of a cured sheet of the prepreg as claimed in claim 6, and a copper foil which is bonded to at least one side of said substrate.

9. A printed wiring board comprising a substrate formed of a cured sheet of the prepreg as claimed in claim 6, and a wiring circuit formed of a copper foil which is formed on at least one side of said substrate.

10. A halogen-free nonflammable epoxy resin composition for a build-up type multi-layer board, which comprises, as essential components:
(A) at least one kind of a cross-linked phosphazene compound;
(B) at least one kind of polyepoxide compound;
(C) a curing agent for epoxy;
(D) a cure promoter for epoxy; and
(E) a thermoplastic resin or a thermosetting resin having a weight average molecular weight of 10,000 or more;
wherein the epoxy resin composition further comprises 0 to 50% by weight of an inorganic filler.

11. A halogen-free nonflammable epoxy resin composition for a build-up type multi-layer board according to claim 10, wherein the cross-linked phenoxyphosphazene compound is obtained by cross-linking at least one kind of phosphazene compound selected from a cyclic phenoxyphosphazene compound represented by the following structural formula (1) and linear phenoxyphosphazene compound represented by the following structural formula (2), by using at least one kind of cross-linking group selected from the group consisting of o-phenylene group, m-phenylene group, p-phenylene group and bis-phenylene group represented by the following general formula (I); the cross-linked phenoxyphosphazene compound being further featured in that:
(a) The cross-linking group is interposed between a pair of oxygen atoms which are derived from the elimination of phenyl group in the phosphazene compound;
(b) The ratio of the phenyl groups in the cross-linked compound is 50 to 99.9% based on the total number of phenyl groups existing in at least one compound selected from the aforementioned cyclic phenoxyphosphazene compound and linear phenoxyphosphazene compound; and
(c) There is no free hydroxyl group in the molecule thereof; 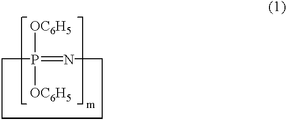
wherein
m is an integer ranging from 3 to 25. 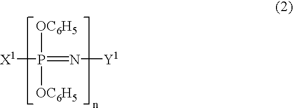
wherein
X¹ is a group of —N═P(OC₆H₅)₃ or —N═P(O)OC₆H₅; Y¹ is a group of —P(OC₆H₅)₄ or —P(O)(OC₆H₅)₂; and n is an integer ranging from 3 to 10000. 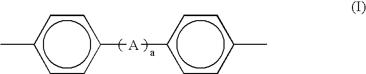
wherein
A is —C(CH₃)₂—, —SO₂—, —S— or —O—; and a is an integer of 0, 1 or more.

12. A halogen-free nonflammable epoxy resin composition for a build-up type multi-layer board according to claim 10, wherein the polyepoxide compound is glycidyl ether-based epoxy resin.

13. A halogen-free nonflammable epoxy resin composition for a build-up type multi-layer board according to claim 10, wherein the curing agent for epoxy is at least one kind of material selected from the group consisting of dicyandiamide and the derivatives thereof, novolac type phenol resin, amino-modified novolac type phenol resin, polyvinyl phenol resin, boron trifluoride-amine complex, organic acid hydrazide, diaminomaleonitrile and the derivatives thereof, melamine and the derivatives thereof, amine imide, polyamine salts, molecular sieve, amine, acid anhydride, polyamide and imidazole.

14. A halogen-free nonflammable epoxy resin composition for a build-up type multi-layer board according to claim 10, wherein the cure promoter for epoxy is at least one kind of material selected from the group consisting of tertiary amine, imidazole and aromatic amine.

15. A resin coated copper foil comprising a nonflammable epoxy resin composition, which is coated on one side of a copper foil and dried to semi-cure the epoxy resin composition, the nonflammable epoxy resin composition comprising, as essential components: (A) at least one kind of a cross-linked phosphazene compound; (B) at least one kind of polyepoxide compound; (C) a curing agent for epoxy; (D) a cure promoter for epoxy; and (E) a thermoplastic resin or a thermosetting resin having a weight average molecular weight of 10,000 or more; wherein the epoxy resin composition further comprises 0 to 50% by weight of an inorganic filler.

16. A build-up type laminate comprising a plurality of the resin coated copper foils as claimed in claim 15, which are successively laminated on at least one side of an inner circuit board, wherein the copper foil of the resin coated copper foil which is located inside the laminate is etched to form a circuit.

17. A build-up type multi-layer board comprising a plurality of the resin coated copper foils as claimed in claim 15, which are successively laminated on at least one side of an inner circuit board, wherein the copper foils of the resin coated copper foils which are located inside and on the surface of the laminate are etched to form a circuit, and desired portions of the circuits located inside and on the surface of the laminate are electrically connected to each other via a through-hole.

18. A carrier-attached resin film comprising a nonflammable epoxy resin composition, which is coated on one side of a carrier sheet, and dried to semi-cure the epoxy resin composition, the nonflammable epoxy resin composition comprising, as essential components: (A) at least one kind of a cross-linked phosphazene compound; (B) at least one kind of polyepoxide compound; (C) a curing agent for epoxy; (D) a cure promoter for epoxy; and (E) a thermoplastic resin or a thermosetting resin having a weight average molecular weight of 10,000 or more; wherein the epoxy resin composition further comprises 0 to 50% by weight of an inorganic filler.
